(19) United States
(12) Patent Application Publication
(10) Pub. No.: US 2026/0088401 A1
(43) Pub. Date: Mar. 26, 2026

(54) Can Lid, Battery Cell, Battery Pack and Vehicle Including the Same

(71) Applicant: LG Energy Solution, Ltd., Seoul (KR)

(72) Inventors: Sung-Min Cho, Daejeon (KR); Jun-Ho Baek, Daejeon (KR); Seung-Hun Lee, Daejeon (KR); Tae-Rim Hong, Daejeon (KR)

(73) Assignee: LG Energy Solution, Ltd., Seoul (KR)

(21) Appl. No.: 19/327,311

(22) Filed: Sep. 12, 2025

(30) Foreign Application Priority Data
Sep. 24, 2024 (KR) 10-2024-0129269

(51) Int. Cl. H01M 50/107; H01M 50/152; H01M 50/159; H01M 50/164; H01M 50/249; H01M 50/342; H01M 50/54; H01M 50/645

(52) U.S. Cl. CPC H01M 50/107; H01M 50/152; H01M 50/159; H01M 50/164; H01M 50/249; H01M 50/3425; H01M 50/54; H01M 50/645; H01M 2220/20

(57) ABSTRACT

A battery cell may include an electrode assembly, a cell housing, and a can lid. The cell housing includes a sidewall portion, an opening at a first end of the cell housing in an axial direction, and a bottom portion at a second end of the cell housing in the axial direction. The cell housing is configured to accommodate the electrode assembly. The can lid includes a vent notch portion, an edge portion, and an electrode coupling portion. The can lid is configured to cover the opening of the cell housing. The can lid includes a first surface facing away from the electrode assembly in an axial direction and a second surface facing the electrode assembly in the axial direction. The vent notch portion is on the first surface of the can lid.

### CROSS-REFERENCE TO RELATED APPLICATIONS

This application claims priority under 35 U.S.C. § 119 to Korean Patent Application No. 10-2024-0129269 filed on Sep. 24, 2024, the entire contents of which are incorporated herein by reference.

### TECHNICAL FIELD

The present disclosure relates to a can lid, a battery cell, a battery pack, and a vehicle including the same.

### BACKGROUND

Secondary batteries having high energy density are applicable to many product groups including portable electronic devices, electric vehicles (EVs) and hybrid electric vehicles (HEVs) driven by electric power sources. Such secondary batteries are attracting attention as a new energy source to improve eco-friendliness and energy efficiency because they may dramatically reduce the use of fossil fuels, and no by-products may be generated from the use of energy stored within such secondary batteries.

Secondary batteries are being used in battery modules or battery packs in which multiple battery cells are overlapped or stacked and then electrically connected to form a dense structure to provide high voltage and high current. At this time, it is common to first configure a battery module including at least one battery cell, and then configure a battery pack by adding other components to this at least one battery module. Alternatively, in recent years, battery packs in the form of cell to pack, in which multiple battery cells are directly stored in a pack housing or the like without being modularized are also being manufactured.

There is an increasing demand for battery cells in the form of metal cans that may be used in vehicle battery packs. The shape of the metal can may be prismatic or cylindrical. A cylindrical battery cell may have a structure in which a jelly-roll-shaped electrode assembly is accommodated inside the cylindrical can and has the advantage of being more resistant to shock or temperature changes than a pouch-type battery cell.

### SUMMARY

### Technical Problem

The process of manufacturing a battery cell using a cylindrical can may include a step of manufacturing a can by deep drawing a metal sheet to mold a circular bottom (closed surface) and a circular tubular side wall portion connected thereto. The process may include accommodating an electrode assembly inside the can, and then covering the open end of the can with a can lid. The can lid may be joined to the can by butt welding or a beading and crimping method. The use of butt welding to join the can lid to the can is attracting attention because it has the advantage of increasing the internal capacity of the battery cell while having the same external shape relative to a battery cell formed using the beading and crimping method.

Battery cells may be exposed to various environments depending on the use state and conditions, and it is important to reduce the risk of explosion of the battery cells in a wide range of conditions for the safety of users. In general, high temperature and high pressure inside battery cells may lead to an explosion of the battery cells. High internal temperature and high internal pressure may be caused by abnormal operating conditions of the battery cells, such as an internal short circuit, a charging state exceeding the allowed current and voltage, exposure to high temperature, shock by falling, and the like. Therefore, a means of relieving high pressure within a battery cell should be provided, since high pressure is the direct cause of battery cell explosion. If a means of relieving high pressure is properly provided in battery cells where the can lid is joined to the can using butt welding, the safety of the battery pack including such battery cells will be further enhanced.

The present disclosure is designed to solve the above-described problems, and therefore aspects of the present disclosure are directed to a can lid including a means of relieving high pressure.

Aspects of the present disclosure are also directed to a battery cell including such a can lid.

Aspects of the present disclosure are also directed to providing a battery pack and a vehicle including such a battery cell.

### Technical Solution

A battery cell according to the present disclosure may comprise an electrode assembly, a cell housing, and a can lid. The cell housing comprises a sidewall portion, an opening at a first end of the cell housing in an axial direction, and a bottom portion at a second end of the cell housing in the axial direction. The cell housing is configured to accommodate the electrode assembly therein. The can lid comprises a vent notch portion, an edge portion, and an electrode coupling portion. The can lid is configured to be positioned to cover the opening of the cell housing. The can lid comprises a first surface facing away from the electrode assembly in the axial direction and a second surface facing the electrode assembly in the axial direction. The vent notch portion is on the first surface of the can lid.

In one or more aspects, the vent notch portion is between the electrode coupling portion and the edge portion in a radial direction.

In one or more aspects, the vent notch portion has a V-shaped or a U-shaped cross-section in the axial direction.

In one or more aspects, the vent notch portion defines a closed loop shape along the first surface of the can lid.

In one or more aspects, the can lid comprises a first plating layer at the first surface, and the can lid comprises a second plating layer at the second surface.

In one or more aspects, the can lid comprises nickel-plated steel.

In one or more aspects, the edge portion of the can lid is joined to the side wall portion of the cell housing at the first axial end of the cell housing.

In one or more aspects, the electrode coupling portion of the can lid extends further into an interior of the cell housing in the axial direction than the edge portion of the can lid.

In one or more aspects, the electrode coupling portion of the can lid contacts the electrode assembly and the edge portion of the can lid is spaced apart from the electrode assembly.

In one or more aspects, the can lid comprises a plurality of electrode coupling portions and each of the plurality of electrode coupling portions contacts the electrode assembly.

In one or more aspects, the plurality of electrode coupling portions are spaced apart from each other in a circumferential direction.

In one or more aspects, the can lid comprises a plurality of bridges and each bridge of the plurality of bridges is between adjacent electrode coupling portions of the plurality of electrode coupling portions in the circumferential direction.

In one or more aspects, the plurality of the electrode coupling portions are arranged rotationally symmetrically on the can lid about a center of the can lid.

In one or more aspects, the can lid further comprises an injection port at a center of the can lid.

In one or more aspects, the can lid further comprises a flat portion surrounding the injection port, and wherein the flat portion is between the injection port and the electrode coupling portion in a radial direction.

In one or more aspects, the electrode assembly comprises a first electrode, a second electrode, and a separator interposed between the first electrode and the second electrode.

In one or more aspects, the first electrode comprises a first uncoated portion, the second electrode comprises a second uncoated portion, and the second uncoated portion of the second electrode is directly connected to the electrode coupling portion of the can lid.

In one or more aspects, the bottom portion of the cell housing comprises a through hole, a terminal extends through the through hole of the bottom portion of the cell housing, and the terminal is electrically connected to the first uncoated portion of the first electrode.

In one or more aspects, a battery pack may comprise the battery cell

In one or more aspects, a vehicle may comprise the battery pack.

### Advantageous Effects

According to aspects of the present disclosure, a can lid may include a vent notch portion that serves as a means of relieving high pressure in a battery cell.

A battery cell including the can lid of the present disclosure may be configured to relieve high pressure within the battery cell, which is a cause of battery cell explosion, by rupture of the vent notch portion when gas within the battery cell reaches a certain pressure or more.

The can lid of the present disclosure may also be stably and evenly formed so it is flat relative to an electrode assembly, so that the welding quality of the electrode assembly to the can lid may be improved.

The can lid of the present disclosure may also be optimized with respect to various dimensions such as the welding flatness with the electrode assembly, the welding length, and the diameter of the injection port.

According to another aspect of the present disclosure, a battery cell may include the can lid according to an aspect of the present disclosure. In such a battery cell energy density may be increased compared to a battery cell sealed using a beading and crimping method.

According to still another aspect of the present disclosure, a bonding part between the can lid and the cell housing is simplified. In such aspects, there is no need to use a current collector plate when electrically connecting the electrode assembly to the can lid. This may reduce the number of parts and assembly man-hours and further increase the internal volume of the battery cell, thereby increasing energy density.

### BRIEF DESCRIPTION OF THE DRAWINGS

The accompanying drawings illustrate aspects of the present disclosure and together with the disclosure, serve to provide a further understanding of the technical features of the present disclosure. Thus, the present disclosure is not limited to the aspects depicted in the drawings.

FIG. 1 is a perspective view schematically depicting a battery cell according to an aspect of the present disclosure.

FIG. 2 is a side cross-sectional view of a battery cell according to an aspect of the present disclosure.

FIG. 3 is a plan view of a can lid according to an aspect of the present disclosure.

FIG. 4A is a side cross-sectional view taken along section line A-A′ in FIG. 3.

FIG. 4B is a side cross-sectional view showing, in an enlarged manner, a region around an injection port of a battery cell according to an aspect of the present disclosure.

FIG. 5 is a side cross-sectional view of a can lid according to an aspect of the present disclosure.

FIG. 6 is a perspective view of a can lid according to an aspect of the present disclosure.

FIG. 7 is a plan view of a can lid according to an aspect of the present disclosure.

FIG. 8 is a side cross-sectional view taken along section line A-A′ in FIG. 7.

FIG. 9 is a perspective view of a conventional can lid.

FIG. 10 is a table comparing the vent pressures of a can lid according to the present disclosure and those of a conventional can lid.

FIG. 11 is a perspective view schematically depicting a battery pack according to an aspect of the present disclosure.

FIG. 12 is a schematic view for describing a vehicle including a battery pack according to an aspect of the present disclosure.

### DETAILED DESCRIPTION

Hereinafter, aspects of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the aspects described in this specification and the configurations illustrated in the drawings are only some of the aspects of the present disclosure and are not intended to entirely represent the technical features of the present disclosure. Accordingly, it should be understood that various equivalents and modifications may be made thereto at the time of filing the present application.

Additionally, the present disclosure includes various aspects. For each aspect, duplicate descriptions of substantially identical or similar configurations will be omitted, and differences will be mainly described.

Meanwhile, terms indicating directions such as upper, lower, left, right, front, and rear may be used in the present disclosure, but these terms are only for convenience of description in distinguishing different relative directions from one another. It is therefore to be understood that the terms may vary depending on the position of a reference object or an observer, and such terms are not to be interpreted as being limited to, for example, a particular orientation with respect to the direction of gravity.

For convenience of description, the direction along the longitudinal direction of the winding axis of the electrode assembly wound in the form of a jelly-roll in the present specification is referred to as the axial direction. And, the direction surrounding the winding axis is referred to as the circumferential direction or the perimeter direction. And, the direction closer to or away from the winding axis is referred to as the radial direction.

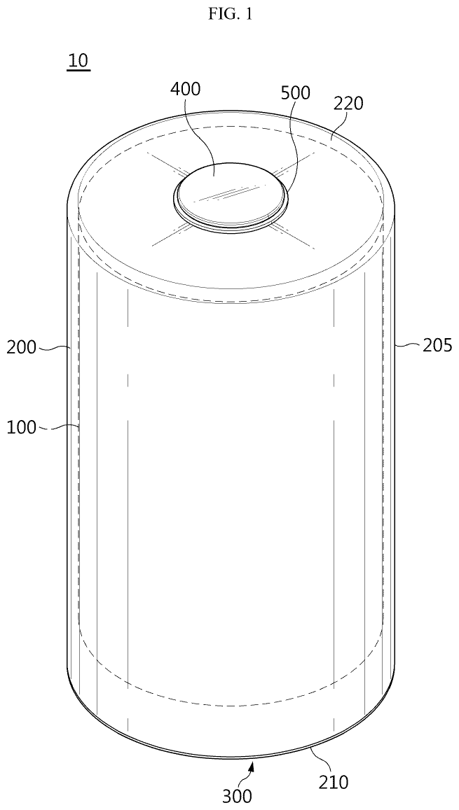

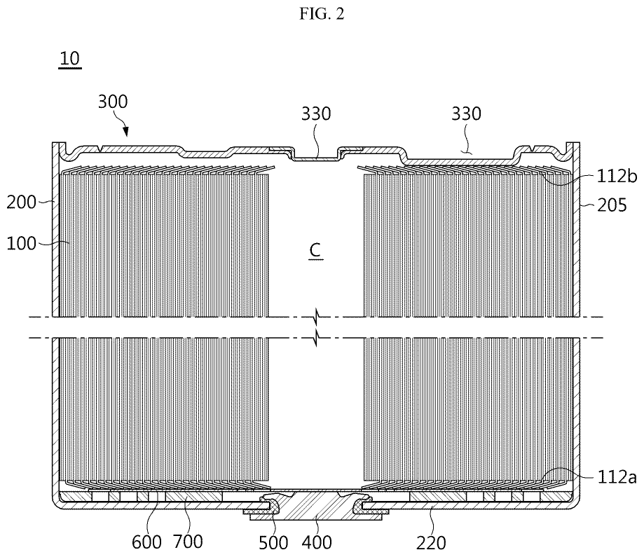

FIG. 1 is a perspective view schematically depicting a battery cell according to an aspect of the present disclosure, and FIG. 2 is a side cross-sectional view of a battery cell according to an aspect of the present disclosure.

Referring to FIGS. 1 and 2, a battery cell 10 according to an aspect the present disclosure may include an electrode assembly 100, a cell housing 200, and a can lid 300.

The battery cell 10 may be a secondary battery configured to be chargeable and dischargeable. For example, the battery cell 10 may be a cylindrical battery cell.

The electrode assembly 100 may include a first electrode and a second electrode and a separator interposed therebetween. The first electrode may have a first polarity, and the second electrode may have a second polarity that is opposite to the first polarity. For example, the first polarity may be positive, and the second polarity may be negative. In the following description the first electrode may be referred to as a positive electrode and the second electrode may be referred to as a negative electrode. However, it should be understood that in any of the aspects described herein, the described polarity of the first and second electrodes may be modified or reversed.

The electrode assembly 100 may be formed by stacking the first electrode and the second electrode and the separator interposed therebetween. The stack of the first electrode, the second electrode, and the separator of the electrode assembly 100 may be wound around winding center hole C to form a jelly-roll. The electrodes (the first electrode and the second electrode) may each have an uncoated portion 112a, 112b that does not include an active material. The uncoated portions 112a, 112b may be located along a longitudinal edge of each electrode prior to winding, such that the uncoated portions 112a, 112b are positioned at an axial end of the electrode assembly 100 after winding. The uncoated portion 112a, 112b may have a plurality of notched foil tabs. Additional details regarding the electrodes with their uncoated portions and notched tabs may be found in U.S. Patent Application Publication No. 2023/0395950 (hereinafter “the incorporated '950 Publication”), the entire contents of which are incorporated by reference herein.

This electrode assembly 100 may be accommodated inside the cell housing 200. The cell housing 200 may comprise an opening in a first end of the cell housing 200 in the axial direction. The electrode assembly 100 may be inserted through the opening in the first end of the cell housing 200 such that the electrode assembly 100 is accommodated within the cell housing 200.

The cell housing 200 may be a can including a side wall portion 205, an opening 210 provided at the first end of the side wall portion 205 in the axial direction, and a bottom portion 220 connected to a second end of the side wall portion 205 in the axial direction. In other words, the can may include a bottom portion 220 and a side wall portion 205 connected to the bottom portion 220 and extending in the axial direction. The first end of the side wall portion 205 that is not connected to the bottom portion 220 may define an opening 210 of the can.

A terminal 400 may be disposed on the bottom portion 220 of the cell housing 200. A center of the bottom portion 220 may comprise a through hole, and at least a portion of the terminal 400 may extend through the through hole. The terminal 400 may be fixed to the bottom portion 220 with a terminal gasket 500 interposed between the bottom portion 220 and the terminal 400. The terminal 400 may be connected to the first electrode of the electrode assembly 100 and may have a first polarity. The terminal 400 may be in the form of a rivet. The terminal 400 is electrically connected to the first uncoated portion 112a of the first electrode.

The bottom portion 220 and the side wall portion 205 of the cell housing 200 may be manufactured by molding a metal sheet by a deep drawing process, and trimming the front end of the side wall portion 205 with a punch while gripping it with a blank holder. In some aspects, the metal sheet may be a steel sheet plated with nickel. Of course, the material of the cell housing 200 is not limited thereto. For example, the material of the cell housing 200 may be a conductive metal, such as aluminum, steel, stainless steel, or the like, but is not limited thereto.

An insulator 700 may be interposed between the positive electrode current collector plate 600 and the bottom portion 220 of the cell housing 200 to electrically insulate the positive electrode current collector plate 600 and the bottom portion 220. The positive electrode current collector plate 600 and the terminal 400 may be bonded by a method such as resistance welding, ultrasonic welding, or laser welding, so that the terminal 400 may be connected to the first electrode of the electrode assembly 100.

A can lid 300 may be coupled to the side wall portion 205 of the cell housing 200 at the first end of the cell housing 200 in the axial direction. The can lid 300 may cover the opening 210. The can lid 300 may cover the electrode assembly 100. The can lid 300 may be forcibly fitted into the opening 210 such that the can lid 300 may be at least temporarily secured within the opening 210 by a press fit. The can lid 300 may later be more permanently secured to the cell housing 200, such as by welding, as discussed below.

The can lid 300 may be electrically connected to the cell housing 200. In one or more aspects, the side wall portion 205 of the cell housing 200 at the first end of the cell housing 200 in the axial direction and the edge of the can lid 300 may be bonded so that the cell housing 200 and the can lid 300 are electrically connected while the electrode assembly 100 is accommodated inside the cell housing 200.

The bonding may be performed by welding, brazing, or soldering.

The can lid 300 may have a disk shape to cover the opening 210 of the cell housing 200. And, the can lid 300 may be press fit into the opening 210 of the cell housing 200.

The can lid 300 may be coupled to the cell housing 200 using butt welding. In such aspects, the battery cell 10 may have a larger internal capacity than a battery cell having the same external shape but using a beading and crimping method of closure. Therefore, energy density may be increased.

The can lid 300 may be electrically connected to the cell housing 200. The can lid 300 may be connected to the second electrode of the electrode assembly 100. In such aspects, the can lid 300 may have a second polarity, and the cell housing 200 electrically connected to the can lid 300 may also have the second polarity. In some aspects, the bottom of the cell housing 200 and the side wall portion 205 connected thereto may both have the second polarity.

In one or more aspects, the cell housing 200 may have a positive terminal and a negative terminal disposed at the same end of the cell housing 200 in the axial direction. For example, the cell housing 200 may have a positive terminal and a negative terminal at the second end, i.e., at the bottom, of the cell housing 200 in the axial direction. Busbars connected to the terminals of both polarities may all be positioned at the same end of the cell housing 200 in the axial direction. In such aspects, the electrical connection structure of a plurality of battery cells 10 may be simplified since both the positive electrode and the negative electrode face the same side of the battery cell 10 in the axial direction. Additionally, since the battery cell 10 according to the present disclosure has a structure in which most of the bottom of the cell housing 200 may be used as a terminal of the second polarity, there is an advantage of securing a sufficient area for welding components for electrical connection.

In one or more aspects, the battery cell 10 may be a cylindrical secondary battery having, for example, a form factor ratio (ratio of diameter to height) greater than approximately 0.4. For example, the diameter of the battery cell 10 may be 40 mm to 50 mm, and the height may be 60 mm to 130 mm. The form factor of the battery cell 10 may be, for example, 46110, 4875, 48110, 4880, or 4680.

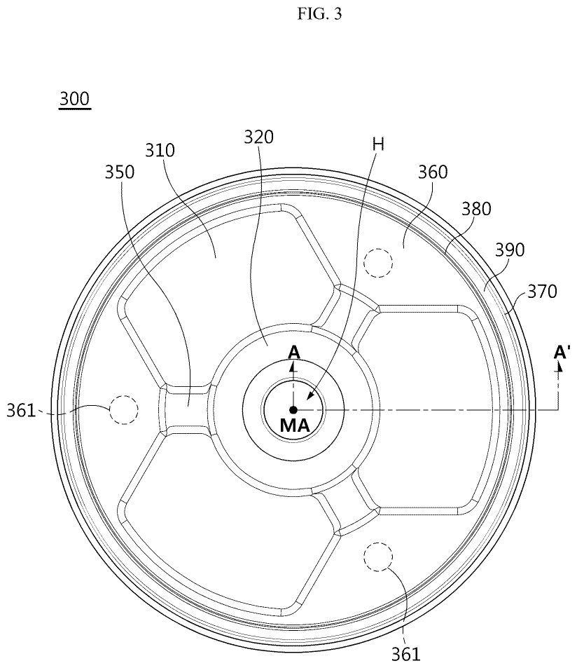

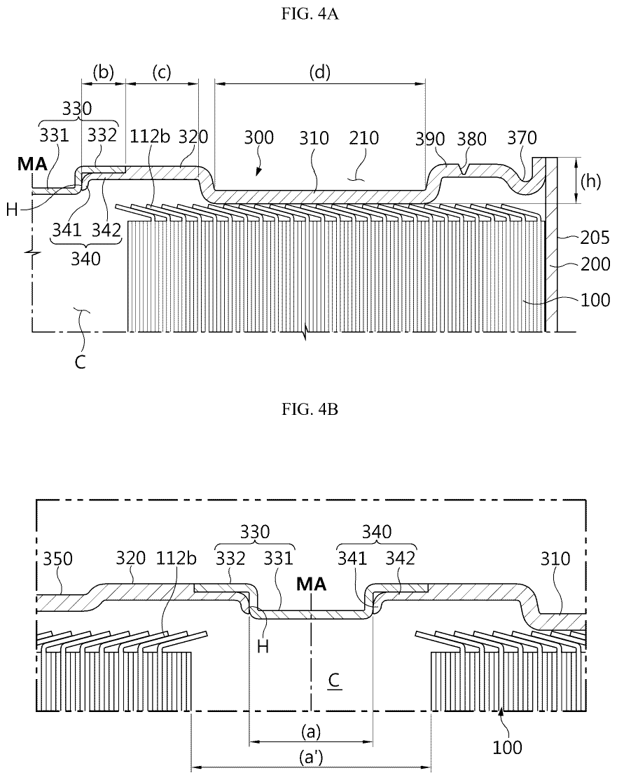

FIG. 3 is a plan view of a can lid 300 according to an aspect of the present disclosure, and FIG. 4A is a side cross-sectional view taken along section line A-A′ in FIG. 3. FIG. 4B is a side cross-sectional view showing, in an enlarged manner, a region around an injection port H of a battery cell 10 according to an aspect of the present disclosure.

Referring to FIGS. 3 and 4, the can lid 300 according to an aspect of the present disclosure may include an injection port H, a flat portion 320, an edge portion 370, and a plurality of electrode coupling portions 310.

The injection port H may be configured such that an electrolyte may be injected into the cell housing 200 through the injection port H. The injection port H may be positioned approximately in the center of the can lid 300. For example, a central axis of the cell housing 200 may pass through the injection port H.

The flat portion 320 may surround the injection port H. The flat portion 320 may extend from the injection port H in a radial direction and may surround the injection port H in a circumferential direction. The flat portion 320 may be have an at least partially flat shape. In some aspects, the flat portion 320 may comprise one or more major surfaces that are substantially normal to the central axis of the cell housing 200.

The edge portion 370 of the can lid 300 may include an edge of the can lid 300 configured to be coupled to the cell housing 200. The edge portion 370 may be coupled to an opening 210 on the first end of the cell housing 200 in a force-fitting (or press fit) manner. The edge portion 370 may be coupled to the cell housing 200 by butt welding after being forcibly fitted into the opening 210 on the first end of the cell housing 200. The cross-section of the edge portion 370 may be approximately U-shaped. The edge portion 370 of the can lid 300 may be at least slightly spaced apart from the electrode assembly 100 along the axial direction, as shown in FIG. 4.

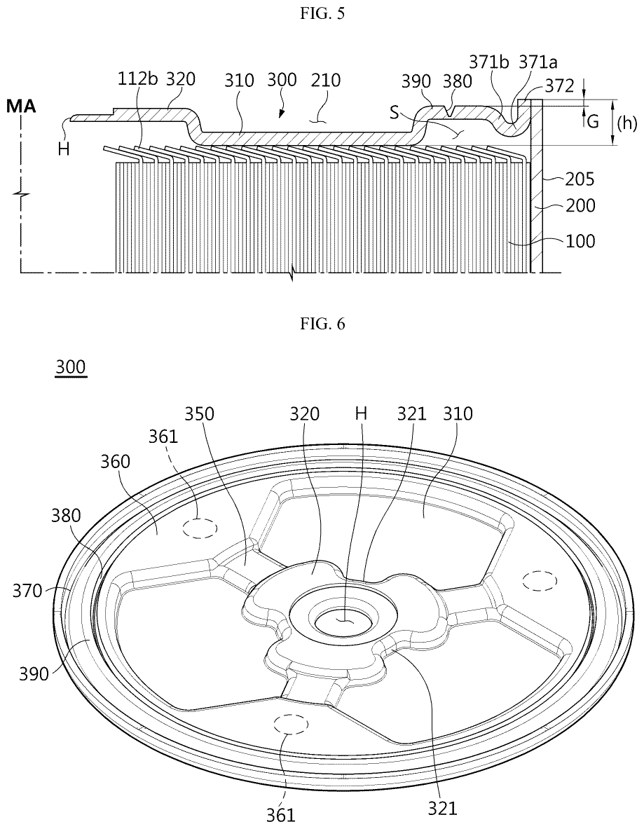

As shown in FIG. 5, the edge portion 370 of the can lid 300 may include a mating surface 372, a curved surface 371a, and an inclined surface 371b. The curved surface 371a may be between the mating surface 372 and the inclined surface 371b. The mating surface 372 may be spaced apart from a central axis of the battery cell 10 in a radial direction a greater distance than the curved surface 371a and the inclined surface 371b. In one or more aspects, the mating surface 372 may be along the perimeter of the can lid 300. The mating surface 372, the curved surface 371a, and the inclined surface 371b may form an approximately U-shaped bent portion 321.

The outer edge of the can lid 300 in the radial direction may comprise the mating surface 372. The mating surface 372 may extend axially so that the outer circumferential surface thereof contacts the inner circumferential surface of the side wall portion 205 of the cell housing 200. The curved surface 371a is connected to the lower end of the mating surface 372 of the can lid 300, that is, the lower end of the mating surface 372 in the axial direction, and has a downwardly convex cross-sectional shape that extends inward radially toward the central axis of the cell housing 200. The slope of the curved surface 371a gradually decreases as it moves away from the mating surface 372. Since the mating surface 372 extends axially, the slope of the tangent line of the outer circumferential surface of the curved surface 371a may gradually decrease from 90 degrees as it moves away from the mating surface 372. The inclined surface 371b continues from the curved surface 371a. The inclined surface 371b extends upwardly in the axial direction as it progresses inwardly in the radial direction, and the slope thereof may be constant. The U shape at the edge of the can lid 300 may be configured such that the can lid 300 may be press fit into the opening 210 at the first end of the cell housing 200.

The curved surface 371a and the inclined surface 371b provide shape that allows the edge portion 370 of the can lid 300 to be elastically deformed radially inward. Accordingly, when the can lid 300 is pressed into the opening 210, the can lid 300 may be fitted into the opening 210 as the U-shape is compressed and then spread without causing deformation of other parts of the can lid 300. Accordingly, a radial adhesion between the side wall portion 205 of the cell housing 200 and the mating surface 372 may be secured. In other words, the mating surface 372 between the can lid 300 and the cell housing 200 may have a snug fit without being distorted during the process of pressing the can lid 300 into the opening 210 of the cell housing 200.

The mating surface 372 may have a length less than or equal to 0.7 mm in the axial direction.

The electrode coupling portion 310 of the can lid 300 may be coupled to the electrode assembly 100. In one or more aspects, the electrode coupling portion 310 of the can lid 300 may be directly connected to the electrode assembly 100. The electrode coupling portion 310 may be coupled to the electrode assembly 100 by welding. In one or more aspects, the bottom surface (the surface facing the electrode assembly 100) of the electrode coupling portion 310 may be coupled to the electrode assembly 100 in a face-to-face manner. The second uncoated portion 112b of the second electrode is directly connected to the electrode coupling portion 310 of the can lid 300. The bottom surface of the electrode coupling portion 310 may be coupled to the second uncoated portion 112b of the electrode assembly 100. That is, the second uncoated portion 112b may have the foil tabs, and the foil tabs along the upper axial end of the electrode assembly 100 maybe bent in the radial direction (e.g., radially inwardly), such that the upwardly oriented surfaces of the tabs after bending may come into contact with and be welded to the electrode connecting portions of the can lid 300 (e.g., the bottom surface of the electrode coupling portion 310), similar to the manner disclosed in the incorporated '950 Publication.

The electrode coupling portion 310 may be between the flat portion 320 and the edge portion 370 of the can lid 300. For example, the flat portion 320, the electrode coupling portion 310, and the edge portion 370 of the can lid 300 may be sequentially disposed along the radial direction. The can lid 300 may comprise a plurality of electrode coupling portions 310, and each electrode coupling portion 310 of the plurality of electrode coupling portions 310 may be spaced apart from each other. For example, the plurality of electrode coupling portions 310 may be spaced apart from each other in the circumferential direction.

Each of the plurality of electrode coupling portions 310 may be recessed downwardly in the axial direction relative to the flat portion 320 and the edge portion 370 of the can lid 300. Specifically, the electrode coupling portions 310 may be recessed toward the electrode assembly 100. The bottom surface of each of the plurality of the electrode coupling portions 3110 may be closer to the electrode assembly 100 than the remainder of the bottom surface of the can lid 300. In such aspects, when the electrode coupling portions 310 are coupled to the electrode assembly 100, the remaining portion of the can lid 300 may be spaced at least slightly apart from the electrode assembly 100.

The can lid 300 according to an aspect of the present disclosure may comprise a plurality of electrode coupling portions 310 that are spaced apart from each other and recessed such that the flat portions 320 of each of the plurality of electrode coupling portions 310 are in substantially the same plane. This may result in a relatively flat surface that may be stably joined to the electrode assembly 100. This may improve the welding quality between the can lid 300 and the electrode assembly 100 according to an aspect of the present disclosure.

The electrode coupling portion 310 may comprise a bottom surface that extends in the radial direction and is normal to the central axis of the cell housing 200. The height of the bottom surface of the electrode coupling portion 310 may be less than the height of the lower end of the curved surface 371a. For example, the electrode coupling portion 310 may protrude further axially into the cell housing 200 than the curved surface 371a. In one or more aspects, the lower end of the curved surface 371a may be spaced apart from the electrode assembly 100 inside the cell housing 200 in the axial direction, while the bottom surface of the electrode coupling portion 310 may be in close contact with the electrode assembly 100. Accordingly, the coupling process between the electrode coupling portion 310 and the electrode assembly 100 may be smoothly performed.

Meanwhile, since the can lid 300 according to aspects of the present disclosure may be coupled to the cell housing 200 to cover the opening 210 of the cell housing 200 and simultaneously may be electrically connected to the electrode assembly 100, a separate current collector plate such as a negative electrode current collector plate need not be included in the battery cell 10. In one or more aspects, the can lid 300 according to the present disclosure may be an integrated can lid 300 capable of performing the functions of a current collector plate and a can lid 300 simultaneously. In such aspects, a current collector plate is not interposed between the can lid 300 and the electrode assembly 100. In some aspects, the battery cell 10 may be free from a negative electrode current collector plate.

The can lid 300 may be electrically connected to the cell housing 200. For example, the can lid 300 may be electrically connected to the cell housing 200 through the coupling portion of the mating surface 372 of the edge portion 370 of the can lid 300 and the inner circumferential surface of the side wall portion 205 of the cell housing 200. The can lid 300 may be laser welded to the cell housing 200, and the electrode coupling portion 310 of the can lid 300 may be laser welded to the uncoated portion 112b of the second electrode of the electrode assembly 100. Then, the can lid 300 may serve as a negative electrode current collector plate.

The electrode coupling portion 310 may extend toward the flat portion 320 and the edge portion 370 of the can lid 300. Specifically, the electrode coupling portion 310 may extend radially inwardly toward the flat portion 320, and the electrode coupling portion 310 may extend radially outwardly toward the edge portion 370. In this case, the length (d) of the electrode coupling portion 310 in the radial direction, which can affect a lid foil tab welding (LFW) length between the electrode coupling portion 310 and the foil tabs, may have a length such that the internal resistance of the battery cell 10 may be reduced.

The can lid 300 may comprise a plurality of electrode coupling portions 310, which may be spaced apart circumferentially with respect to the center of the can lid 300. In one or more aspects, the can lid 300 may comprise three electrode coupling portions 310. When the can lid 300 comprises three electrode coupling portions 310, the plurality of electrode coupling portions 310 may easily form one plane, and thus a stable connection with the electrode assembly 100 may be secured more easily. However, it should be understood that the can lid 300 may comprise any suitable number of electrode coupling portions 310. For example, the can lid 300 may comprise 1, 2, 3, 4, 5, 6, 7, 8, 9, 10 or more electrode coupling portions 310.

The electrode coupling portion 310 may be formed by any suitable manufacturing method, such as a plastic processing method, so that a predetermined part of the can lid 300 in the form of a metal sheet is recessed axially downward. The bonding part of the electrode coupling portion 310 and the electrode assembly 100 may each extend in the radial direction.

The inner circumferential surface of the side wall portion 205 of the cell housing 200 and the mating surface 372 of the can lid 300 may be pressed against each other to be bonded.

The can lid 300 according to an aspect of the present disclosure may further include at least one bridge 350. In some aspects, the can lid 300 may comprise a plurality of bridges 350. For example, the can lid 300 may comprise 1, 2, 3, 4, 5, 6, 7, 8, 9, 10, or more bridges 350. In some aspects, the can lid 300 may comprise three bridges 350. Each bridge 350 may extend radially from the flat portion 320. In one or more aspects, a bridge 350 may separate two adjacent electrode coupling portions 310 in the circumferential direction. The bridge 350 may extend from the flat portion 320 toward the edge portion 370. Alternatively, the bridge 350 may extend from the flat portion 320 toward the picking portion 360 to be described later.

The plurality of electrode coupling portions 310 may be partitioned and spaced apart by the plurality of bridge 350 portions. Additionally, the bridge 350 may improve the rigidity of the can lid 300.

In one or more aspects, the upper surface of the bridge 350 may be at a height greater than the upper surface of the electrode coupling portion 310, but less than the upper surface of the flat portion 320. When the bridge 350 is formed in this way, the rigidity of the can lid 300 may be further improved.

The plurality of electrode coupling portions 310 may be formed and disposed symmetrically relative to the center of the can lid 300. Each of the electrode coupling portions 310 may be formed in the same shape and may be disposed to form an equiangular angle with respect to the can lid 300. In this way, when the plurality of electrode coupling portions 310 are formed and disposed symmetrically, a stable connection between the can lid 300 and the electrode assembly 100 may be secured, and the electrical stability of the battery cell 10 may also be improved.

The can lid 300 according to an aspect of the present disclosure may further include a plug coupling portion 340. The plug coupling portion 340 may surround the injection port H in a circumferential direction. The injection port H may be in the center of the plug coupling portion 340. The plug coupling portion 340 may be shaped such that a plug 330 may be inserted into and seated on the plug coupling portion 340. The plug 330 may be configured to seal the injection port H when inserted into and seated on the plug coupling portion 340. The plug 330 may be formed by deep drawing a thin metal sheet of 0.3 mm. If the thin metal sheet is too thin, molding is difficult and rigidity is insufficient. The total height of the plug 330 may be 1.5 mm to 1.7 mm.

The plug coupling portion 340 may have an insertion portion 341 and a seating portion 342. A plug 330 may be inserted into the insertion portion 341. The insertion portion 341 of the plug coupling portion 340 may extend axially toward an interior of the cell housing 200. The plug 330 may have a protrusion 331 shaped to be inserted into the insertion portion 341. The protrusion 331 of the plug 330 may be coupled to the insertion portion 341 of the plug coupling portion 340 in a force-fitting manner. The insertion portion 341 of the plug coupling portion 340 may be an outer edge of the injection port H, and when the protrusion 331 of the plug 330 is inserted into the insertion portion 341 of the plug coupling portion 340, the injection port H may be sealed.

The plug 330 may be seated on the seating portion 342. The plug 330 may have an extension portion 332 configured to contact the seating portion 342 of the plug coupling portion 340. The extension portion 332 of the plug 330 may extend in the radial direction from the insertion portion 341. The seating portion 342 of the plug coupling portion 340 may extend radially from the insertion portion 341 of the plug coupling portion 340. The seating portion 342 of the plug coupling portion 340 may be stepped so that the extension portion 332 of the plug 330 may be seated on the seating portion 342. The extension portion 332 of the plug 330 and the seating portion 342 of the plug coupling portion 340 of the can lid 300 may be coupled to each other by welding.

As described above, when the can lid 300 includes the plug coupling portion 340, the coupling between the plug 330 and the can lid 300 may be improved, and the injection port H may be effectively sealed.

In one or more aspects, the insertion portion 341 protrudes into an interior of the cell housing 200 in an axial direction less than the electrode coupling portion 310 of the can lid 300. Since the insertion portion 341 is slightly higher than the electrode coupling portion 310, it may be spaced apart from the electrode assembly 100. This may prevent damage to the electrode assembly 100 by preventing the plug welding heat from being transferred to the separator of the electrode assembly 100.

Referring to FIG. 4A, length (b) of the seating portion 342 is a radial distance from the injection port H to the flat portion 320 of the can lid 300. As the length (b) of the seating portion 342 from the injection port H to the end of the flat portion 320 increases, the weldability between the seating portion 342 and the extension portion 332 of the plug 330 may be improved. The length (b) may be designed to prevent welding defects of the plug 330 due to the heat of vaporization of the electrolyte. In one or more aspects, the length (b) may be from 1 mm to 3 mm. For example, the length (b) may be 2 mm. In such aspects, the outer diameter of the seating portion 342 is 4 mm larger than the diameter of the injection port H. The seating portion 342 may be formed, for example, by a forging method.

Still referring to FIG. 4A, length (c) is a length of the flat portion 320 extending radially from the plug coupling portion 340 to the electrode coupling portion 310. The length (c) of the flat portion 320 may be an appropriate length to secure a flat surface for the electrode coupling portion 310. For example, the length (c) may be 3 mm or more. If the length (c) is less than 3 mm, it may be difficult to mold the flat portion 320.

The injection port H may have a shape in which a pipe portion is formed through piercing and burring, or may be a hole through which the insertion portion 341 is pierced.

FIG. 5 depicts a modified can lid 300 relative to the aspect of the can lid 300 depicted in FIG. 4. Referring to FIG. 5, the injection port H is formed by piercing.

Referring to FIG. 4B, the can lead 300 may be configured such that the center of the winding center hole C and the center of the injection port H coincide with the central axis MA of the cell housing 200. Accordingly, the can lead 300 and the electrode assembly 100 may be arranged in a concentric structure with each other.

When the can lead 300 is configured as described above, uniform injection of the electrolyte can be achieved during electrolyte filling through the injection port H. In addition, when a welding rod is inserted through the injection port H into the winding center hole C, interference with the winding center hole C can be prevented, and such insertion can be easily and precisely carried out.

In FIGS. 4 and 5, the injection port H may be a hole through which an electrolyte may be injected and through which a welding rod may be passed. For example, a current collector plate (e.g., a positive electrode current collector plate 600) and a rivet-shaped terminal 400 may be disposed on an opposite axial end of the battery cell 10 from the injection port H, and a welding rod may be inserted through the injection port H into the winding center hole C of the electrode assembly 100 to weld the current collector plate and the terminal 400. Accordingly, the diameter (a) of the injection port H may be larger than the diameter of the welding rod in order to avoid interference of the welding rod. Additionally, the diameter (a) of the injection port H may be smaller than the size (a′) of the winding center hole C for stable injection of the electrolyte. If the diameter (a) of the injection port H is larger than the size (a′) of the winding center hole C, the separator in the winding center hole C part of the electrode assembly 100 may loosen or come off when the electrolyte is injected at high pressure. The diameter (a) of the injection port H taking this into account may be 5 mm to 5.5 mm in one or more aspects of the present disclosure.

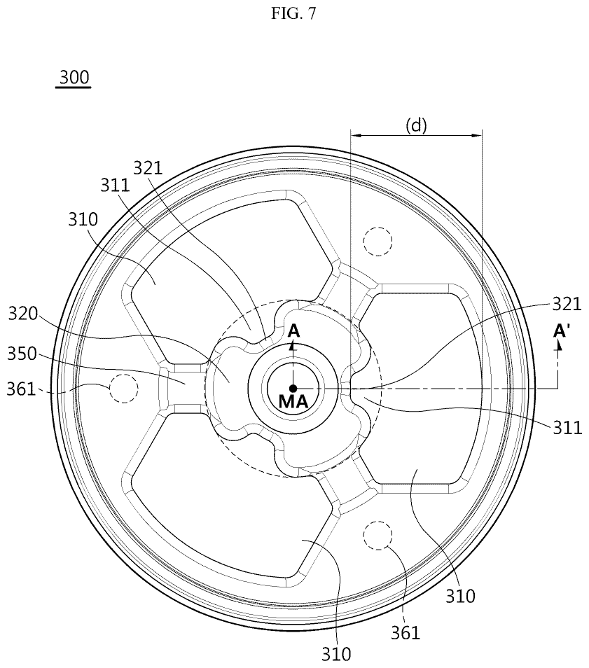

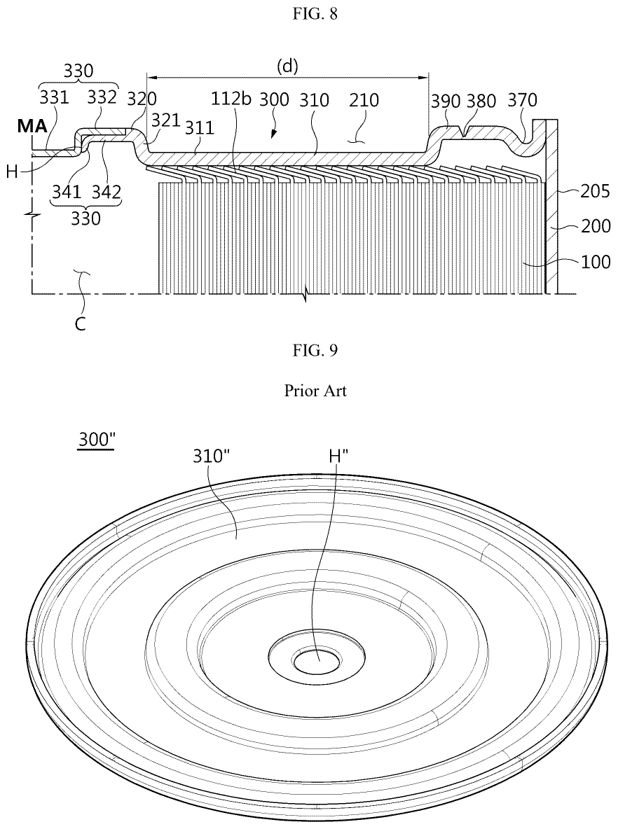

FIG. 6 is a perspective view of a can lid 300 according to another aspect of the present disclosure, FIG. 7 is a plan view showing a can lid 300 according to another aspect of the present disclosure, and FIG. 8 is a side cross-sectional view taken along section line A-A′ in FIG. 7.

Referring to FIGS. 6 to 8, a can lid 300 according to another aspect of the present disclosure may have a bent portion 321 and an electrode coupling portion 310, and the electrode coupling portion 310 may comprise an extended portion 311.

The bent portion 321 may be an indentation in the perimeter of the flat portion 320 in the axial direction. For example, when the flat portion 320 of the can lid 300 has a substantially circular shape, the bent portion 321 may be an indentation from the substantially circular perimeter of the flat portion 320 in the axial direction toward the injection port H. The can lid 300 may comprise one or more bent portions 321. In some aspects, the can lid 300 may comprise the same number of bent portion 321 and electrode coupling portions 310. The extended portion 311 may extend from the electrode coupling portion 310 toward the bent portion 321 in the radial direction. The extended portion 311 may occupy at least a portion of the indentation in the flat portion 320 formed by the bent portion 321. The extended portion 311 may further extend toward the injection port H as much as the bent portion 321 is recessed. For example, a radial edge of the extended portion 311 facing the bent portion 321 may have substantially the same shape as a radial edge of the bent portion 321 facing the extended portion 311. In one or more aspects the bent portion 321 may be directly connected to the extended portion 311.

In such aspects, when the flat portion 320 and the electrode coupling portion 310 each have a bent portion 321 and an extended portion 311, the length (d), which is the length of the electrode coupling portion 310 in the radial direction and affects the welding length between the electrode coupling portion 310 and the electrode assembly 100, may be further increased. This may reduce the internal resistance of the battery cell 10. For example, when the can lid 300 does not have a bent portion 321 and an extended portion 311, the length (d) may be about 9 mm, and when the can lid 300 has a bent portion 321 and an extended portion 311, the length (d) may be longer, about 12 mm.

In such aspects, the length (c) in the remainder of the flat portion 320, excluding the bent portion 321, may be easily secured, and the length (a) and/or the length (b) may be easily secured. This may improve the rigidity of the can lid 300. Additionally, as the internal resistance of the battery cell 10 may be reduced, the width (in the circumferential direction) of the electrode coupling portion 310 may be reduced, thereby easily securing the picking portion 360 to be described later.

When the length (a), length (b), length (c), and length (d) are designed as described above, various dimensions of the can lid 300, including the welding flatness and welding length of the can lid 300, and the diameter (a) of the injection port H, may be optimized.

When the above-described can lid 300 is used, a bonding part between the can lid 300 and the cell housing 200 is simplified, and there is no need to use a current collector plate when electrically connecting the electrode assembly 100 to the cell housing 200. This may reduce the number of parts and assembly man-hours needed to produce the battery cell 10. This may also increase the internal volume of the battery cell 10 available for the electrode assembly 100, thereby increasing energy density of the battery cell 10.

Referring to FIGS. 2 to 8, the can lid 300 according to aspects of the present disclosure may further include a vent notch portion 380.

The vent notch portion 380 is included on a surface of the can lid 300 facing away from the electrode assembly 100. In one or more aspects, the can lid 300 may comprise a first surface facing away from the electrode assembly 100 in the axial direction and a second surface facing the electrode assembly 100 in the axial direction. The vent notch portion 380 may be on the first surface of the can lid 300. For example, the vent notch portion 380 may be on an exterior surface of the can lid 300 that faces away from the interior of the cell housing 200.

In one or more aspects, the vent notch portion 380 may be formed on the upper part of the can lid 300. The vent notch portion 380 may be formed on the upper surface of the can lid 300.

The vent notch portion 380 may be configured to be ruptured by an increase in the internal pressure of the battery cell 10 above a maximum internal pressure. The vent notch portion 380 may be configured to release a high-temperature venting gas when a thermal event occurs in the battery cell 10, and accordingly, the venting gas may be discharged from the battery cell 10 to an area outside the battery cell 10 through the ruptured vent notch portion 380. The vent notch portion 380 may comprise a notch extending along the circumferential direction on the inner side of the edge portion 370 of the can lid 300.

The rupture pressure of the cell housing 200 may be controlled by controlling the depth and width of the vent notch portion 380. For example, the vent notch portion 380 may be configured to be ruptured when the pressure inside the cell housing 200 is in the range of 15 kgf/cm² to 35 kgf/cm². The vent notch portion 380 may be formed by partially reducing the thickness of the can lid 300 to form a notch or indentation. The vent notch portion 380 may have a thickness gradient. The thickness gradient means that when the cross-section of the vent notch portion 380 is checked, it is inclined at a certain angle based on a predetermined horizontal plane. This vent notch portion 380 is ruptured when the pressure inside the cell housing 200 rises above a predetermined pressure, so that at least a portion of the internal gas is discharged to an area outside the battery cell 10.

In one or more aspects, the thickness of the can lid 300 may be from 0.4 mm to 0.8 mm. For example, the thickness of the can lid 300 may be 0.6 mm.

In one or more aspects, the battery cell 10 may be a 4680 battery cell. For a 4680 battery cell, when the thickness of the side wall portion 205 is considered and the one-side force-fitting amount is designed to be about 110 μm, the diameter of the can lid 300 may be 45.2 mm.

In a cross-section of the can lid 300 in the axial direction, the vent notch portion 380 may have a V-shaped or U-shaped cross-section.

In an upper surface of the can lid 300, the vent notch portion 380 may have a closed loop shape. In such aspects, the vent notch portion 380 may extend continuously on the upper surface of the can lid 300 in the circumferential direction around at least a portion of the can lid 300.

The vent notch portion 380 may be ruptured when the pressure inside the cell housing 200 exceeds a threshold. The vent notch portion 380 may form a continuous or discontinuous circular pattern, a linear pattern, or other patterns on the surface of the can lid 300. For example, the vent notch portion 380 may be formed in a roughly circular ring shape having a certain width. This circular ring-shaped vent notch portion 380 may have the same center as the center of the can lid 300.

The vent notch portion 380 may be formed by (unidirectional) notching only on one surface of the can lid 300. For example, the surface of the can lid 300 facing the interior of the cell housing 200 may not be notched and the surface of the can lid 300 facing away from the interior of the cell housing 200 may be notched.

When the vent notch portion 380 is formed on the can lid 300, the venting gas may be easily discharged from the battery cell 10. Since the vent notch portion 380 is provided on the can lid 300 and does not occupy a separate space within the battery cell 10, energy density of the battery cell 10 may be improved.

The can lid 300 may be a metal sheet including a plating layer on both surfaces. The can lid 300 comprises a first plating layer at the first surface, and the can lid 300 comprises a second plating layer at the second surface. For example, the can lid 300 may be nickel-plated steel (NPS).

In aspects where the can lid 300 comprises NPS, peeling of nickel plating may occur during the notching process. Therefore, when the vent notch portion 380 is formed only on the upper part of the can lid 300, there is no concern about foreign substances being introduced to the electrode assembly 100.

If the steel below the nickel plating is exposed through notching, there may be a problem of corrosion such as fluoride being generated when in contact with the electrolyte. In aspects where the vent notch portion 380 is formed on the side of the can lid 300 that does not face the electrode assembly 100 as in aspects of the present disclosure, there is no concern about contact of the vent notch portion 380 with the electrolyte, resulting in no problem of corrosion.

If the notch is on the side of the can lid 300 that faces the electrode assembly 100, the notched portion may be damaged by expansion and contraction of the electrode assembly 100 occurring during the activation and charging and discharging processes. If the vent notch portion 380 is on the side of the can lid 300 that does not face the electrode assembly 100, as in the aspects of the present disclosure, the problem of damage to the vent notch portion 380 due to expansion and contraction of the electrode assembly 100 is fundamentally prevented.

By forming the vent notch portion 380 in the upper surface of the can lid 300 in this way, corrosion of the can lid 300 or contact with the electrode assembly 100 may be avoided. This may result in normal operation of the battery cell 10 while maintaining the shape of the vent notch portion 380.

The vent notch portion 380 may be further from the injection port H than the electrode coupling portion 310 in the radial direction. For example, the vent notch portion 380 may be between the electrode coupling portion 310 and the edge portion 370 of the can lid 300.

In one or more aspects, the electrode coupling portion 310 is recessed in the axial direction relative to the flat portion 320 and the edge portion 370 of the can lid 300. In such aspects, the vent notch portion 380 may be in a part of the can lid 300 that is not recessed to the same extent or to a greater extent than the electrode coupling portion 310. In such aspects, the portion of the can lid 300 comprising the vent notch portion 380 is spaced apart from the electrode assembly 100 in the axial direction. Referring to FIG. 5, a space S is provided between the vent notch portion 380 and the electrode assembly 100, so that gas may gather in this space S. When the gas pressure in this part exceeds a predetermined value, the vent notch portion 380 may be ruptured and the gas may be discharged to an area outside of the battery cell 10. If the vent notch portion 380 is in a part of the can lid 300 that is recessed toward the electrode assembly 100, it will be difficult to gather gas between the electrode assembly 100 and the vent notch portion 380 of the can lid 300 as described above, and it will not be easy to rupture the vent notch portion 380.

In one or more aspects, the can lid 300 may further include a support surface 390 comprising a flat surface between the inclined surface 371b of the edge portion 370 and the electrode coupling portion 310. The vent notch portion 380 may be formed on this support surface 390. The electrode coupling portion 310 is connected to an inner side of the support surface 390 in the radial direction, and the electrode coupling portion 310 may be recessed toward an interior of the cell housing 200 relative to the support surface 390.

The support surface 390 may extend horizontally in the radial direction. The support surface 390 may be further inward toward a central axis of the cell housing 200 in the radial direction than the curved surface 371a of the can lid 300. The support surface 390 is connected to an inner end of the inclined surface 371b in the radial direction, and the support surface 390 may extend horizontally toward the central axis of the cell housing 200 in the radial direction from the connection part. The support surface 390 comprises a flat surface between the inclined surface 371b and the electrode coupling portion 310. In one or more aspects, the surface of the support surface 390 may have a flat ring shape.

The vent notch portion 380 may not be deformed by the force applied to the can lid 300 when the can lid 300 is pressed into the cell housing 200. The vent notch portion 380 may be broken when the internal pressure of the battery cell 10 increases sharply due to a short circuit or the like occurring inside the cell housing 200, so that the electrode coupling portion 310 of the can lid 300 and the mating surface 372 of the can lid 300 may be separated from each other. Accordingly, the electrode coupling portion 310 connected to the electrode assembly 100 and the cell housing 200 are electrically disconnected, and the internal space of the cell housing 200 is opened to the environment outside the battery cell 10, which discharges the gas causing the increase in internal pressure.

An upper surface of the support surface 390 in the axial direction may be disposed lower in the axial direction than an upper end of the mating surface 372. In such aspects, there is a gap G between the upper surface of the mating surface 372 and the upper surface of the support surface 390. Accordingly, when the battery cell 10 is placed on a surface, the vent notch portion 380 may not directly touch the surface, thereby protecting the vent notch portion 380 from unintended damage or rupture.

In one or more aspects, the total height h of the can lid 300 may be 1.0 mm to 3.0 mm. When the total height h of the can lead 300 is less than 1.0 mm, a peripheral portion of the electrode coupling portion 310 may not be reliably spaced apart from the electrode assembly 100 100. When the total height h of the can lead 300 exceeds 3.0 mm, the volume occupied by the can lead 300 increases, which may reduce the energy density of the battery cell 10.

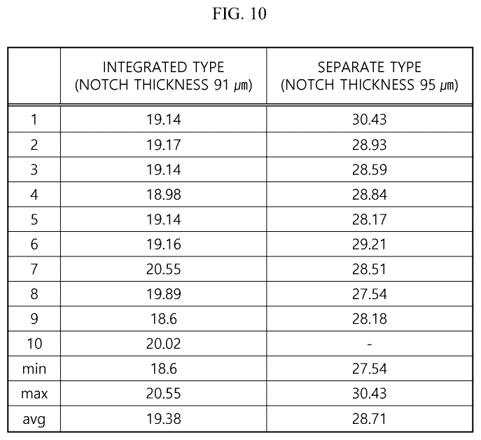

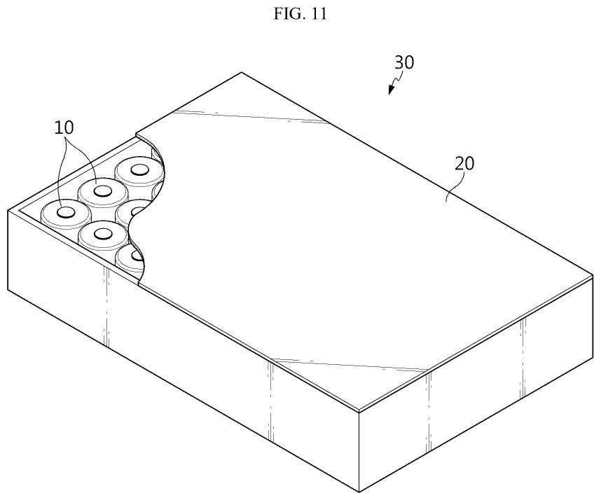

FIG. 9 is a perspective view of a conventional can lid, and FIG. 10 is a table showing a comparison of the vent pressure of a can lid according to the present disclosure and a conventional can lid.

Referring to FIGS. 9 and 10, the vent pressure of a battery cell 10 using the can lid 300 according to an aspect of the present disclosure is lower than that of the conventional battery cell.

A battery cell using the conventional can lid 300″ illustrated in FIG. 9 may include a separate current collector plate between the can lid 300″ and the electrode assembly. In the conventional can lid 300″ illustrated in FIG. 9, the electrode coupling portion 310″ may have a flat plate shape with no overall bending along the periphery of the flat portion 320″ surrounding the injection port H″.

In a conventional battery cell, it was very difficult to properly secure planarity of the can lead 300″ with respect to the electrode assembly. In other words, it was very difficult for the conventional can lead 300″ to properly secure adhesion with the electrode assembly. Specifically, the electrode assembly may be imperfectly planarized, for example, such that a plurality of foil tabs are not completely flattened but formed to be slightly and partially bent. As shown in FIG. 9, the electrode coupling part 310″ of the can lead 300″ in the conventional battery cell could be formed in a single continuous plate shape without bending along the circumferential direction. Due to such a single plate shape, the conventional can lead 300″ was highly likely to form unstable or non-uniform adhesion with the imperfectly planarized electrode assembly as described above, making it very difficult to properly secure adhesion between the can lead 300″ and the electrode assembly.

FIG. 10 shows a comparative experimental example of the vent pressure of the can lid 300 (integrated type) according to an aspect of the present disclosure and the conventional can lid illustrated in FIG. 9. The vent pressure is the internal pressure of the battery cell at which the vent notch portion 380 begins to rupture.

According to FIG. 10, the notch thickness of the vent notch portion 380 of the can lid 300 (integrated type) according to an aspect of the present disclosure and the notch thickness of the vent notch portion of the conventional can lid are at similar levels of 91 μm and 95 μm, respectively. However, the vent pressure of the can lid 300 (integrated type) according to the aspect of the present disclosure was, on average, 19.4 kgf/cm² (dispersion 2.05 kgf/cm²), which is lower than the average vent pressure of the conventional can lid of 28.7 kgf/cm² (dispersion 2.92 kgf/cm²). The vent notch portion 380 of the can lid 300 (integrated type) according to the aspect of the present disclosure has a notch thickness similar to that of the conventional can lid, but has a lower vent pressure. Accordingly, a battery cell 10 using the can lid 300 according to an aspect of the present disclosure has improved safety relative to a battery cell using a conventional can lid.

Referring to FIG. 3 or 7 again, the can lid 300 according to aspects of the present disclosure may further include a picking portion 360.

The picking portion 360 may be between two adjacent electrode coupling portions 310 and the edge portion 370. A picking area 361 may be formed in the picking portion 360. The picking area 361 may be configured to be gripped by a picking device. The diameter of the picking area 361 may be from 2 mm to 6 mm. For example, the diameter of the picking area 361 may be about 4 mm.

When the can lid 300 according to aspects of the present disclosure has a picking portion 360, the picking device may not be in contact with the electrode coupling portion 310. This may prevent foreign substances or the like from flowing into the electrode coupling portion 310 from the picking device, and the can lid 300 may be stably gripped and transferred in the process of assembling the battery cell 10.

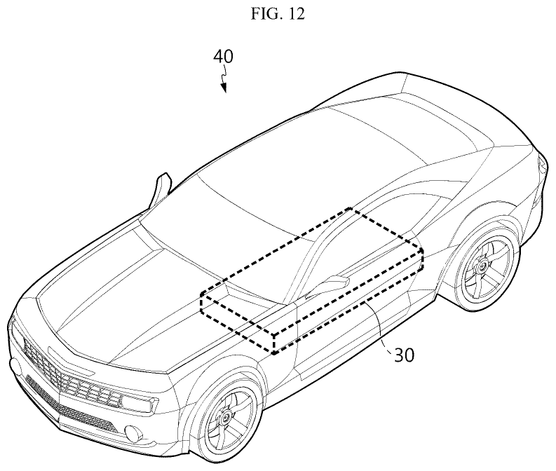

FIG. 11 is a perspective view schematically depicting a battery pack 30 according to an aspect of the present disclosure. FIG. 12 is a schematic depiction of a vehicle 40 including a battery pack 30 according to an aspect of the present disclosure.

The battery cell 10 described above may be accommodated in the housing 20 of the battery pack 30 as shown in FIG. 11. The battery pack 30 may be configured using a plurality of battery modules, which are an intermediate form of assembly that can each contain multiple battery cells 10. Thus, the battery pack 30 may be made up of an arrangement of a plurality of battery modules each containing multiple battery cells 10, or the battery pack 30 may be configured directly by assembling a plurality of battery cells 10 without intervening battery modules, as illustrated in FIG. 11. Since the battery cell 10 has a large volume by itself, there is no particular difficulty in implementing the battery pack 30 even without using an intermediate structure called a battery module. And, since the negative electrode of the battery cell 10 may be connected through the can lid 300, the internal resistance is low and the energy density is high. Additionally, since the vent notch portion 380 is provided on the can lid 300 and does not occupy a separate space, energy density may be further secured. Accordingly, the energy density of the battery pack 30 including the battery cell 10 may be improved.

In one or more aspects, a plurality of battery cells 10 may be included in the battery pack 30. The battery cells 10 are arranged in a predetermined number of rows, and may be arranged so that both the positive terminal and the negative terminal in each battery cell 10 face an upper side of the battery pack 30. In one or more aspects, both the positive and negative electrodes of the plurality of battery cells 10 may be connected in one direction, thereby simplifying the electrical connection structure. Through this, energy density may be improved by increasing the number of battery cells 10 that may be mounted in the same space, and the electrical wiring work may be simplified. Therefore, the space efficiency may be improved, and the electrical wiring efficiency may be improved, so that there is a significant improvement in the process of assembling electric vehicles, as well as during the assembly and maintenance of the battery pack 30. Additionally, each of the battery cells 10 may have a greater energy density than the prior art, as described above. The battery pack 30 with the increased energy density may store the same energy while reducing the volume and mass of the battery pack 30.

Therefore, if the battery pack 30 to which such battery cells 10 are applied is mounted on a vehicle, such as the vehicle 40 using electricity as an energy source as illustrated in FIG. 12, the mileage of the vehicle 40 may be further increased in proportion to the energy consumed.

The vehicle 40 according to aspects of the present disclosure may include the battery pack 30. The vehicle 40 may be a hybrid vehicle or an electric vehicle. The vehicle 40 according to aspects of the present disclosure may further include various other components included in the vehicle 40 in addition to the battery pack 30. For example, the vehicle 40 according to the present disclosure may further include a vehicle body, a motor, a control device such as an electronic control unit (ECU), or the like, in addition to the battery pack 30 according to aspects of the present disclosure.

In one or more aspects, electrical wiring may be performed on the bottom of the cell housing 200, the side of the cell housing 200 where the terminal 400 is positioned, and may not be performed on the can lid 300 positioned at the opposite side of the cell housing 200. This may maximize the effectiveness of the vent notch portion 380 on the can lid 300. Additionally, if a heat sink, a cooling plate, or a tray is positioned on the can lid 300 side of the cell housing 200, the purpose of assembly and cooling may be effectively achieved without interference from the electrical wiring connection. In addition, the gas discharged from the inside of the secondary battery will desirably be discharged downward by assembling the vent notch portion 380 to face downward. In one or more aspects, the secondary battery is mounted below the passenger compartment of a vehicle 40. Thus if the gas were to be discharged upward from the secondary battery, it may cause harm to the passengers. The battery cell 10 of the present disclosure, on the other hand, may effectively discharge high-pressure gas inside the secondary battery in a downward direction, away from the passenger compartment. This may reduce the likelihood that gas emitted from the secondary battery may harm the passengers of the vehicle 40, and thus may improve the safety of the vehicle 40. Additionally, the gas emitted from the secondary batter is less likely to damage the electrical wiring connections at the top of the battery cell 10.

Aspects of the present disclosure have been described with reference to the accompanying drawings. However, various modifications and variations on the aspects described in the present disclosure are possible without departing from the scope of the present disclosure. Therefore, the scope of the present disclosure should be construed by the claims which follow.

### DESCRIPTION OF REFERENCE NUMERALS

10: Battery cell
20: Housing
30: Battery pack
40: Vehicle
100: Electrode assembly
112a, 112b: Uncoated portion
200: Cell housing
205: Sidewall portion
210: Opening
220: Bottom portion
300: Can lid
310: Electrode coupling portion
311: Extended portion
320: Flat portion
321: Bent portion
330: Plug
331: Protrusion
332: Extension portion
340: Plug coupling portion
341: Insertion portion
342: Seating portion
350: Bridge
360: Picking portion
361: Picking area
370: Edge portion
371a: curved surface
371b: Inclined surface
372: Mating surface
380: Vent notch portion
390: Support surface
400: Terminal
500: Terminal gasket
600: positive electrode current collector plate
700: Insulator
H: Injection port

1. A battery cell comprising:
an electrode assembly;
a cell housing comprising a side wall portion, an opening at a first end of the cell housing in an axial direction, and a bottom portion at a second end of the cell housing in the axial direction, wherein the cell housing accommodates the electrode assembly therein; and
a can lid comprising a vent notch portion, an edge portion, and an electrode coupling portion;
wherein the can lid is positioned to cover the opening of the cell housing;
wherein the can lid comprises a first surface facing away from the electrode assembly in the axial direction and a second surface facing the electrode assembly in the axial direction;
wherein the vent notch portion is on the first surface of the can lid.

2. The battery cell of claim 1, wherein the vent notch portion is between the electrode coupling portion and the edge portion in a radial direction.

3. The battery cell of claim 1, wherein the vent notch portion has a V-shaped cross-section or a U-shaped cross-section in the axial direction.

4. The battery cell of claim 1, wherein the vent notch portion defines a closed loop shape along the first surface of the can lid.

5. The battery cell of claim 1, wherein the can lid comprises a first plating layer at the first surface, and the can lid comprises a second plating layer at the second surface.

6. The battery cell of claim 1, wherein the can lid comprises nickel-plated steel.

7. The battery cell of claim 1, wherein the edge portion of the can lid is joined to the side wall portion of the cell housing at the first axial end of the cell housing.

8. The battery cell of claim 1, wherein the electrode coupling portion of the can lid extends further into an interior of the cell housing in the axial direction than the edge portion of the can lid.

9. The battery cell of claim 1, wherein the electrode coupling portion of the can lid contacts the electrode assembly and the edge portion of the can lid is spaced apart from the electrode assembly.

10. The battery cell of claim 1, wherein the can lid comprises a plurality of electrode coupling portions and each of the plurality of electrode coupling portions contacts the electrode assembly.

11. The battery cell of claim 10, wherein the plurality of electrode coupling portions are spaced apart from each other in a circumferential direction.

12. The battery cell of claim 11, wherein the can lid comprises a plurality of bridges and each bridge of the plurality of bridges is between adjacent electrode coupling portions of the plurality of electrode coupling portions in the circumferential direction.

13. The battery cell of claim 10, wherein the plurality of the electrode coupling portions are arranged rotationally symmetrically about a center of the can lid.

14. The battery cell of claim 1, wherein the can lid further comprises an injection port at a center of the can lid.

15. The battery cell of claim 14, wherein the can lid further comprises a flat portion surrounding the injection port, and wherein the flat portion is between the injection port and the electrode coupling portion in a radial direction.

16. The battery cell of claim 1, wherein the electrode assembly comprises a first electrode, a second electrode, and a separator interposed between the first electrode and the second electrode.

17. The battery cell of claim 16, wherein the first electrode comprises a first uncoated portion, the second electrode comprises a second uncoated portion, and the second uncoated portion of the second electrode is directly connected to the electrode coupling portion of the can lid.

18. The battery cell of claim 17, wherein the bottom portion of the cell housing comprises a through hole, a terminal extends through the through hole of the bottom portion of the cell housing, and the terminal is electrically connected to the first uncoated portion of the first electrode.

19. A battery pack comprising a battery cell of claim 1.

20. A vehicle comprising the battery pack of claim 19.
